(19) United States
(12) Patent Application Publication
(10) Pub. No.: US 2014/0241898 A1
(43) Pub. Date: Aug. 28, 2014

(54) AUTOGENOUSLY WELDED IMPELLER OF A TORQUE CONVERTER

(71) Applicant: Schaeffler Technologies GmbH & Co. KG, Herzogenaurach (DE)

(72) Inventor: Alfredo Jimenez, Woostre, OH (US)

(73) Assignee: Schaeffler Technologies GmbH & Co. KG, Herzogenaurach (DE)

(21) Appl. No.: 14/187,531

(22) Filed: Feb. 24, 2014

Related U.S. Application Data
(60) Provisional application No. 61/770,651, filed on Feb. 28, 2013.

(51) Int. Cl. F16H 41/28

(52) U.S. Cl. CPC F16H 41/28
USPC 416/235; 228/196; 416/223 R

(57) ABSTRACT

A torque converter impeller is provided. The torque converter impeller includes an impeller shell and an impeller hub. The impeller shell and impeller hub are autogenously welded together such that the weld has a concave shape. A method of forming a torque converter impeller is also provided.

This claims the benefit to U.S. Provisional Patent Application No. 61/770,651, filed on Feb. 28, 2013, which is hereby incorporated by reference herein.

The present invention relates generally to torque converter impellers and more specifically to a connection of an impeller hub and an impeller shell of a torque converter impeller.

### BACKGROUND

Conventionally, an impeller hub and an impeller shell of an impeller of a torque converter are connected to each other by adding a weld filler and melting the weld filler to weld the impeller hub and the impeller shell together.

U.S. Pat. No. 7,770,387 discloses a method of autogenously welding a cover and an impeller, or pump, of a torque converter.

### SUMMARY OF THE INVENTION

A torque converter impeller is provided. The torque converter impeller includes an impeller shell and an impeller hub. The impeller shell and impeller hub are autogenously welded together such that the weld has a concave shape.

Embodiments of the torque converter impeller may also include one or more of the following advantageous features:

The impeller hub may include a flange and the impeller hub may be welded to the impeller shell by the flange. The impeller hub may include a tube portion extending away from the impeller shell. An outer diameter of the flange may be at most 30% larger than an outer diameter of the tube portion. The impeller hub may be melted at the weld. The weld may be formed by TIG welding. The impeller shell may include an inside surface supporting impeller fins and an outside surface opposite the inside surface, the impeller hub being welded to the outside surface of the impeller shell. The impeller shell and the impeller hub may be welded together such that a transition between the impeller shell and the impeller hub has a concave shape. The impeller shell may include a rounded portion housing the impeller fins and a joining portion radially inside of the rounded portion, the impeller hub including a tube portion approximately perpendicular to the joining portion and a flange extending radially from the tube portion, the flange being melted so as to form the weld connecting the impeller shell and the impeller hub. The weld may be melted such that a smooth transition is formed between the weld and the joining portion. An axial end of the tube portion rests flat against an outer surface of the joining portion, the flange being melted to extend axially past the axial end of the tube portion into the joining portion.

A method of forming a torque converter impeller is also provided. The method includes the steps of aligning an impeller shell with an impeller hub and autogenously welding the impeller hub and the impeller shell together such that a weld joining the impeller hub and the impeller shell has a concave shape.

A torque converter impeller is also provided that includes an impeller shell and an impeller hub including a radially protruding flange. The impeller shell and impeller hub are autogenously welded together by the flange.

### BRIEF DESCRIPTION OF THE DRAWINGS

The present invention is described below by reference to the following drawings, in which:

FIG. 1 shows a cross-sectional view of an impeller of a torque converter; and

FIGS. 2a and 2b show cross-sectional views of how an impeller of a torque converter is formed in accordance with an embodiment of the present invention.

### DETAILED DESCRIPTION

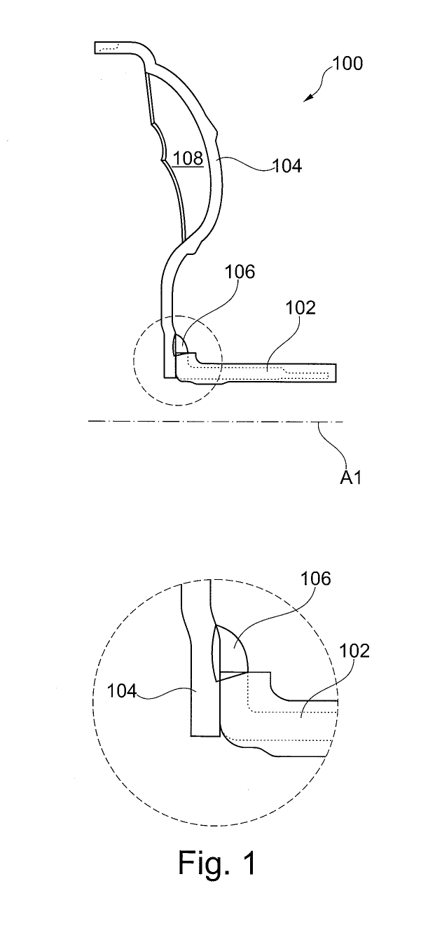

FIG. 1 shows an impeller 100 of a torque converter constructed according to the method described in U.S. Publication No. 2012/015190, which is assigned to the assignee of the present application. Impeller 100 includes an impeller hub 102 and an impeller shell 104 connected to each other by a weld filler 106 and has an axis A1. Impeller shell 104 supports impeller fins 108. As shown in greater detail at the bottom of FIG. 1, a weld geometry of the weld between impeller hub 102 and impeller shell 104 is convex or domed in cross-section and was formed by metal inert gas (MIG) welding.

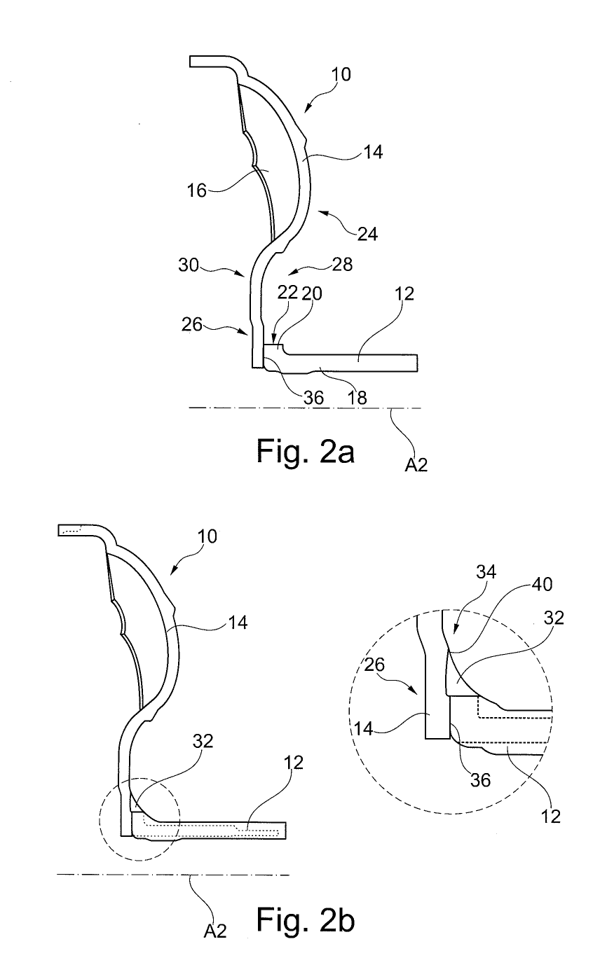

FIGS. 2a and 2b show how an impeller 10 of a torque converter is formed in accordance with an embodiment of the present invention. Impeller 10 includes an impeller hub 12 and impeller shell 14, which supports impeller fins 16, and has an axis A2. FIG. 2a shows impeller hub 12 and impeller shell 14 before they are joined and FIG. 2b shows impeller hub 12 and impeller shell 14 joined together by an autogenous weld. An autogenous weld, in contrast to the weld shown in FIG. 1, is formed by directly welding two components in the absence of a filler material, such as weld filler 106.

As shown in FIG. 2a, before welding, impeller hub 12 includes a tube portion 18 and a flange 20 at an axial end 36 of tube portion 18 extending radially away from tube portion 18. Before welding, an radial outer surface 22 of flange 20 is flat and extends parallel to axis A2, and flange 20 includes an approximately uniform width. Although surface 22 is shown as a cylindrical surface in FIG. 2a, other configurations of surface 22 are possible. For example, in some embodiments (not shown), surface 22 may be a conical surface. Impeller shell 14 includes a rounded portion 24 for housing impeller fins 16 on an inside surface 30 of impeller shell 14 and a joining portion 26 radially inside of rounded portion 24. When impeller hub 12 and impeller shell 14 are aligned for welding, as shown in FIG. 2a, axial end 36 of the tube portion 18 rests flat against an outer surface 28 of joining portion 26. In this alignment, tube portion 18 is approximately perpendicular to joining portion 26 and flange 20 is parallel to joining portion 26. An outer diameter of flange 20 is at most 30% larger than an outer diameter of tube portion 18.

In order to transform impeller 10 from FIG. 2a to FIG. 2b, an autogenous welding is performed to join impeller hub 12 and impeller shell 14. The autogenous welding may be tungsten inert gas (TIG) welding. Energy is applied via a TIG welder to melt flange 20, which upon cooling forms a weld 32 that bonds impeller hub 12 to impeller shell 14. Radial outer surface 22 is reshaped to form a smooth, continuous transition 34 joining impeller hub 12 and impeller shell 14.

Weld area 32 extends from outer surface 28 of impeller shell 14 at joining portion 26 and, in contrast to the weld shown in FIG. 1, includes an outer surface with a concave shape in cross-section, which adds to the strength of the bond formed between impeller hub 12 and impeller shell 14. Additionally, the concave shape provides a smooth transition 34 between joining portion 26 of impeller shell 14 and flange 20 of impeller hub 12 without a sharp corner as shown in FIG. 1. The melting of the impeller hub 12 includes causing radially outer surface 22 of flange 20 to extend radially toward impeller fins 16 and axially toward joining portion 26. As shown in the enlarged portion of FIG. 2b, flange 20 is melted to extend axially past axial end 36 of tube portion 18 and into joining portion 26 of impeller shell 14. The melting of impeller hub 12 causes flange 20 of the impeller hub 12 to taper toward impeller shell 14 and form a point 40.

The welding method described with respect to FIGS. 2a and 2b may improve the durability in the impeller hub/shell rotary bend and may improve manufacturing costs by saving money conventionally spent on material filler. The concave shape of the weld advantageously creates a desirable transition angle between weld 32 and impeller shell 14, improving stress distribution. Additionally, autogenous welding, in particular TIG welding, may also prevent weld splatter, eliminating the need for applying anti-splatter spray to impeller hub 12 and impeller shell 14, and may allow better controlled heat input during welding.

Testing of the impeller 10 shown in FIG. 2b with the impeller 100 shown in FIG. 1 illustrated the improved durability of impeller 10 by 30% compared with impeller 100 when subjected to rotary bend tests until failure. In testing impellers 10, 100 until failure, impeller 10 withstood an additional 1.1 million cycles compared to impeller 100 when tested at the same load.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A torque converter impeller comprising:
an impeller shell; and
an impeller hub, the impeller shell and impeller hub being autogenously welded together such that the weld has a concave shape.

2. The torque converter impeller as recited in claim 1 wherein the impeller hub includes a flange, the impeller hub being welded to the impeller shell by the flange.

3. The torque converter impeller as recited in claim 2 wherein the impeller hub includes a tube portion extending away from the impeller shell.

4. The torque converter impeller as recited in claim 3 wherein an outer diameter of the flange is at most 30% larger than an outer diameter of the tube portion.

5. The torque converter impeller as recited in claim 1 wherein the impeller hub is melted at the weld.

6. The torque converter impeller as recited in claim 5 wherein the weld is formed by TIG welding.

7. The torque converter impeller as recited in claim 1 wherein the impeller shell includes an inside surface supporting impeller fins and an outside surface opposite the inside surface, the impeller hub being welded to the outside surface of the impeller shell.

8. The torque converter impeller as recited in claim 1 wherein the impeller shell and the impeller hub are welded together such that a transition between the impeller shell and the impeller hub has a concave shape.

9. The torque converter impeller as recited in claim 1 wherein the impeller shell includes a rounded portion housing impeller fins and a joining portion radially inside of the rounded portion, the impeller hub including a tube portion approximately perpendicular to the joining portion and a flange extending radially from the tube portion, the flange being melted so as to form the weld connecting the impeller shell and the impeller hub.

10. The torque converter impeller as recited in claim 9 wherein a transition between the weld and the joining portion has a concave shape.

11. The torque converter impeller as recited in claim 9 wherein the weld is melted such that a smooth transition is formed between the weld and the joining portion.

12. The torque converter impeller as recited in claim 9 wherein an axial end of the tube portion rests flat against an outer surface of the joining portion, the flange being melted to extend axially past the axial end of the tube portion into the joining portion.

13. A method of forming a torque converter impeller comprising:
aligning an impeller shell with an impeller hub; and
autogenously welding the impeller hub and the impeller shell together such that a weld joining the impeller hub and the impeller shell has a concave shape.

14. The method as recited in claim 13 wherein the welding comprises applying energy to the impeller hub and melting the impeller hub onto the impeller shell.

15. The method as recited in claim 14 wherein the melting of the impeller hub includes causing a radially outer surface of the impeller hub to extend radially and axially toward the impeller shell.

16. The method as recited in claim 14 wherein the melting of the impeller hub includes tapering a flange of the impeller hub toward the impeller shell.

17. The method as recited in claim 13 wherein the impeller hub and the impeller shell are welded together such that a transition between the impeller hub and the impeller shell has a concave shape.

18. The method as recited in claim 13 wherein impeller shell includes a rounded portion housing the impeller and a joining portion radially inside of the rounded portion, the impeller hub including a tube portion approximately perpendicular to the joining portion and a flange extending radially from the tube portion, the melting including melting the flange so as to form the weld connecting the impeller shell and the impeller hub.

19. The impeller as recited in claim 18 wherein during the aligning an axial end of the tube portion rests flat against an outer surface of the joining portion, the flange being melted to extend axially past the axial end of the tube portion into the joining portion.

20. A torque converter impeller comprising:
an impeller shell; and
an impeller hub including a radially protruding flange, the impeller shell and impeller hub being autogenously welded together by the flange.
